(19) United States
(12) Patent Application Publication
(10) Pub. No.: US 2021/0265648 A1
(43) Pub. Date: Aug. 26, 2021

(54) FUEL CELL SYSTEM AND METHOD OF CONTROLLING FUEL CELL SYSTEM

(71) Applicant: TOYOTA JIDOSHA KABUSHIKI KAISHA, Toyota-shi (JP)

(72) Inventors: Yutaka TANO, Toyota-shi (JP); Osamu YUMITA, Seto-shi (JP); Sho KATO, Anjo-shi (JP); Shinya OOWATARI, Anjo-shi (JP)

(73) Assignee: TOYOTA JIDOSHA KABUSHIKI KAISHA, Toyota-shi (JP)

(21) Appl. No.: 17/176,514

(22) Filed: Feb. 16, 2021

(30) Foreign Application Priority Data
Feb. 25, 2020 (JP) 2020-029211

(51) Int. Cl. H01M 8/04858; H01M 16/00; H01M 8/04082; H01M 8/04537; H01M 50/512; H01M 8/04746

(52) U.S. Cl. CPC H01M 8/04902; H01M 16/006; H01M 8/04201; H01M 8/04552; H01M 2220/20; H01M 50/512; H01M 8/04873; H01M 8/04753; H01M 2250/20; H01M 8/04888

(57) ABSTRACT

A fuel cell system includes: a fuel cell; a reaction gas supplier which supplies a fuel gas and an oxidizing gas to the fuel cell; a first converter which converts the output voltage of the fuel cell; a secondary battery; a connection line connecting the first converter and the secondary battery in parallel to a load; and a controller. The controller includes a first operation mode and a second operation mode. In the first operation mode, the first converter is operated with a step-up capability that is able to be realized by the first converter. In the second operation mode, the first converter is operated with the maximum step-up capability that is able to be realized by the first converter and in which the reaction gas supplier is used to control the output current of the fuel cell.

### CROSS REFERENCE TO RELATED APPLICATIONS

The present application claims the priority based on Japanese Patent Application No. 2020-029211 filed on Feb. 25, 2020, the disclosure of which is hereby incorporated by reference in its entirety.

### BACKGROUND

### Field

The present disclosure relates to a fuel cell system and a method of controlling a fuel cell system.

### Related Art

Conventionally, there is a technology in which low-efficient power generation is performed so as to perform a warm-up operation on the fuel cell system (Japanese Unexamined Patent Application Publication No. 2007-184243). In a fuel cell system, a fuel cell and a DC/DC converter for a fuel cell and a secondary battery and a DC/DC converter for a secondary battery are connected parallel to the inverter of a drive motor.

A fuel cell converts energy included in a fuel gas into electrical energy and thermal energy. In a warm-up operation, a smaller amount of reaction gas than in a normal operation is supplied to the fuel cell. In such a state, an operating point which is a combination of the output voltage and the output current of the fuel cell is controlled. At the controlled operating point, the fuel cell is operated such that the ratio of the thermal energy output from the fuel cell is high and that the ratio of the electrical energy is low. Specifically, the fuel cell is operated at an operating point having a high current and a low voltage.

In the technology of patent literature 1, when a normal operation is shifted to the warm-up operation, an operating point is shifted from an operating point at which the normal operation is performed to an operating point at which the low-efficient operation is performed, while output power is held constant. Specifically, a step-up converter which converts the output voltage of the fuel cell is used, and thus the output voltage of the fuel cell is lowered to a target voltage in the low-efficient operation. On the other hand, the amount of oxidizing gas supplied from an oxidizing gas supply source is adjusted so as to control the output current of the fuel cell. In the technology of patent literature 1, when the normal operation is shifted to the warm-up operation, the output power is held constant, and thus a power device used at the time of the operation of a vehicle and a power device used in the operation of the fuel cell are able to be operated stably.

The warm-up operation of a fuel cell is performed when the temperature of the fuel cell is low. In the warm-up operation of the fuel cell, a smaller amount of reaction gas than in a normal operation is supplied to the fuel cell. In a state where the temperature of the fuel cell is low and where the amount of reaction gas supplied is low, the output voltage of the fuel cell is significantly changed by a slight change in the output current of the fuel cell. Hence, even if it is assumed that the temperature of the fuel cell is constant, the control of an operating point in the warm-up operation is required to be performed with high accuracy.

Furthermore, the characteristics of the fuel cell which are indicated by a combination of the output current and the output voltage from the fuel cell are easily changed by a change in temperature under an environment of a low temperature. Specifically, even when the value of the output current is the same, as the temperature of the fuel cell is increased, the output voltage of the fuel cell is increased. Hence, the control of the operating point in the warm-up operation for increasing the temperature of the fuel cell is required to be performed precisely according to the temperature of the fuel cell.

When the control of the operating point in the warm-up operation is not sufficiently precise, and thus the actual operating point of the fuel cell is displaced from a target operating point, a larger amount of electrical energy than the scheduled amount of electrical energy may be output from the fuel cell. In such a case, excess electrical energy is stored in a secondary battery. However, under an environment of a low temperature, the performance of the secondary battery is lowered. In other words, power which is able to be stored in the secondary battery and power which is able to be discharged therefrom are low. Hence, when the actual operating point of the fuel cell is displaced from the target operating point, power higher than the power which is able to be stored is stored in the secondary battery, and thus the secondary battery may be deteriorated. Likewise, even when the operating point of the fuel cell is displaced, and thus a smaller amount of electrical energy than the scheduled amount of electrical energy is output from the fuel cell, an instruction to discharge power higher than the power which is able to be discharged is provided, with the result that the secondary battery may be deteriorated.

The present disclosure is able to be realized as aspects below.

### SUMMARY

According to one aspect of the present disclosure, a fuel cell system is provided. The fuel cell system includes: a fuel cell; a reaction gas supplier which supplies a fuel gas and an oxidizing gas to the fuel cell; a first converter which converts the output voltage of the fuel cell; a secondary battery; a connection line for connecting the output end of the first converter and the output end of the secondary battery in parallel to a load; and a controller which controls the fuel cell system. The controller includes, as operation modes of the fuel cell system, a first operation mode and a second operation mode. The first operation mode is an operation mode in which the first converter is operated with a step-up capability that is able to be realized by the first converter, and the second operation mode is an operation mode in which the first converter is operated with the maximum step-up capability that is able to be realized by the first converter and in which the reaction gas supplier is used to control the output current of the fuel cell.

### BRIEF DESCRIPTION OF THE DRAWINGS

FIG. 1 shows a fuel cell vehicle 10 on which the fuel cell system 100 of a first embodiment is mounted;

FIG. 2 is a block diagram showing the detailed configuration of an FC converter 150;

FIG. 3 is a graph showing the current IL of a reactor L1;

FIG. 4 is a flowchart showing a method of controlling the fuel cell system 100 with a controller; and

FIG. 5 is an illustrative diagram showing the current-voltage characteristics of a fuel cell 101.

### DETAILED DESCRIPTION

### A. First Embodiment

A1. Configuration of Fuel Cell Vehicle 10:

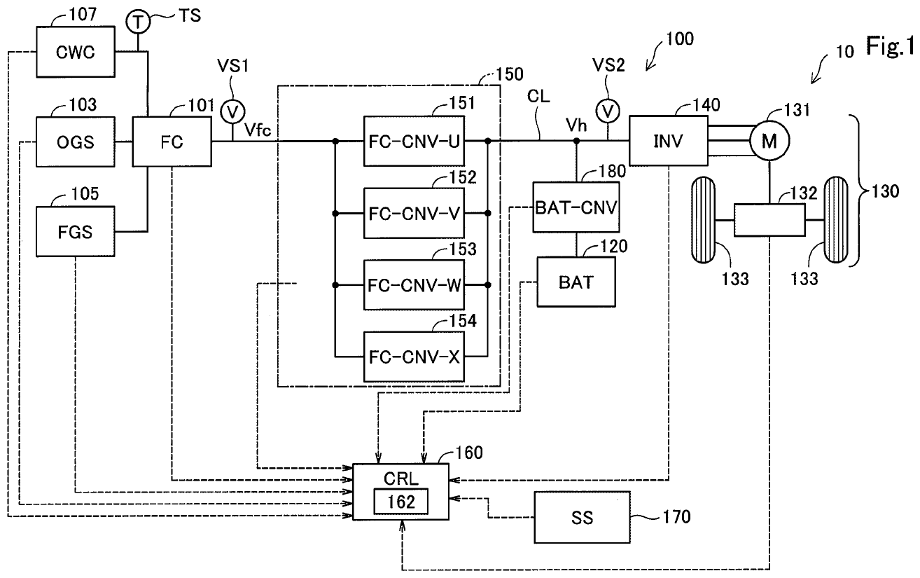

FIG. 1 shows a fuel cell vehicle 10 (Fuel Cell Hybrid Vehicle, hereinafter also referred to as the FCHV 10) on which the fuel cell system 100 of a first embodiment is mounted. The fuel cell vehicle 10 includes the fuel cell system 100, a load 130, an inverter 140, a control device 160 and a sensor group 170. The fuel cell vehicle 10 is mainly driven with power supplied by the fuel cell system 100.

The fuel cell system 100 includes a fuel cell 101, an oxidizing gas supplier 103, a fuel gas supplier 105, a cooling water circulator 107, a secondary battery 120, an FC converter 150 and a battery converter 180.

The fuel cell 101 receives the supply of hydrogen gas serving as a fuel gas and air serving as an oxidizing gas, generates power and supplies the power to the outside (see a left portion of the upper row of FIG. 1). The fuel cell 101 is a polymer electrolyte fuel cell which includes a cell stack that is configured by stacking a plurality of power generation cells in layers. In FIG. 1, the fuel cell 101 is represented by “FC 101”.

The oxidizing gas supplier 103 supplies the air serving as the oxidizing gas to the fuel cell 101 (see the left portion of the upper row of FIG. 1). The oxidizing gas supplier 103 includes a compressor. The oxidizing gas supplier 103 takes in air around the fuel cell vehicle 10, compresses the air and supplies it to the fuel cell 101. In FIG. 1, the oxidizing gas supplier 103 is represented by “OGS 103”.

The fuel gas supplier 105 supplies the hydrogen gas serving as the fuel gas to the fuel cell 101 (see the left portion of the upper row of FIG. 1). The fuel gas supplier 105 includes a hydrogen gas tank which stores high-pressure hydrogen gas. The fuel gas supplier 105 decompresses the hydrogen gas in the hydrogen gas tank, and supplies it to the fuel cell 101. In FIG. 1, the fuel gas supplier 105 is represented by “FGS 105”.

The cooling water circulator 107 circulates cooling water for controlling the temperature of the fuel cell 101 between the cooling water circulator 107 and the fuel cell 101 (see the left portion of the upper row of FIG. 1). The cooling water circulator 107 includes a heat exchanger. The cooling water circulator 107 cools the cooling water discharged from the fuel cell 101 with the heat exchanger, and supplies it to the fuel cell 101 again. In FIG. 1, the cooling water circulator 107 is represented by “CWC 107”.

The secondary battery 120 is able to receive the supply of power and accumulate it, and to supply the power to the outside (see a right portion of the middle row of FIG. 1). Specifically, the secondary battery 120 is a lithium-ion cell. In FIG. 1, the secondary battery 120 is represented by “BAT 120”.

The FC converter 150 is arranged between the fuel cell 101 and the inverter 140 (see a center portion of the upper row of FIG. 1). The FC converter 150 receives the output power of the fuel cell 101, converts the output voltage thereof into a higher voltage and supplies it to the inverter 140. The FC converter 150 is a four-phase parallel converter which is configured with a U phase 151, a V phase 152, a W phase 153 and an X phase 154 that are connected in parallel to each other. The detailed configuration and operation of the FC converter 150 will be described later. In FIG. 1, the U phase 151, the V phase 152, the W phase 153 and the X phase 154 are represented by “FC-CNV-U 151”, “FC-CNV-V 152”, “FC-CNV-W 153” and “FC-CNV-X 154”, respectively.

The battery converter 180 is arranged between the secondary battery 120 and the inverter 140 (see a right portion of the upper row of FIG. 1). The battery converter 180 receives the output power of the secondary battery 120, steps up or steps down the output voltage of the secondary battery 120 and supplies it to the inverter 140. The battery converter 180 receives output power from the inverter 140, steps up or steps down the output power of the inverter 140 and supplies it to the secondary battery 120. In FIG. 1, the battery converter 180 is represented by “BAT-CNV 180”.

The FC converter 150 and the fuel cell 101 and the battery converter 180 and the secondary battery 120 are connected in parallel with respect to the inverter 140. A connection line for connecting the output end of the FC converter 150 and the output end of the secondary battery 120 in parallel to the load 130 is indicated as the connection line CL.

In the present specification, the expression of the “connection line connecting A to B” includes: a configuration in which A and B are directly connected with the connection line; and a configuration in which A and B are connected with the connection line and another constituent element. In the present embodiment, the output end of the FC converter 150 is connected to the load 130 through the connection line CL and the inverter 140. The output end of the secondary battery 120 is connected to the load 130 through the battery converter 180, the connection line CL and the inverter 140.

The load 130 indicates all devices in the fuel cell vehicle 10 which receive the supply of power from the fuel cell 101 and the secondary battery 120 for operation (see the right portion of the upper row of FIG. 1). In FIG. 1, as an example of the load, a traction motor 131 is shown. The traction motor 131 receives the supply of power from the inverter 140 and outputs a rotational force. The rotational force of the traction motor 131 is transmitted though a differential gear 132 to a tire 133 to move the fuel cell vehicle 10.

When the fuel cell vehicle 10 is decelerated, the traction motor 131 functions as a power generator and supplies regenerative power to the inverter 140. The regenerative power is supplied through the inverter 140 and the battery converter 180 to the secondary battery 120 and is stored in the secondary battery 120.

The inverter 140 converts the direct-current power supplied from the fuel cell 101 or the secondary battery 120 into three-phase alternating-current power, and supplies it to the traction motor 131 (see the right portion of the upper row of FIG. 1). The inverter 140 is a PWM inverter which is driven with a pulse width modulation. In FIG. 1, the inverter 140 is represented by “INV 140”.

The sensor group 170 indicates sensors attached to devices which configure the fuel cell vehicle 10 (see a right portion of the lower row of FIG. 1). From the sensors of the sensor group 170, for example, a signal indicating an accelerator opening, a signal indicating a vehicle speed, a signal indicating the output current of the fuel cell 101, a signal indicating the output terminal voltage of the fuel cell 101 and the like are supplied to the control device 160. In FIG. 1, the sensor group 170 is represented by “SS 170”. As an example of the sensor group 170, a voltage sensor VS1 which measures the output terminal voltage Vfc of the fuel cell 101, a voltage sensor VS2 which measures the output terminal voltage Vh of the battery converter 180 and a temperature sensor TS which measures the temperature tw of the cooling water in the fuel cell 101 are indicated (see the left portion of the upper row and the right portion of the upper row of FIG. 1).

The control device 160 is a computer system which includes a CPU (Central Processing Unit) serving as a processor, a RAM (Random Access Memory) and a ROM (Read Only Memory) (see a center portion of the lower row of FIG. 1). The control device 160 controls the fuel cell vehicle 10.

For example, based on various types of signals supplied from the sensor group 170, the control device 160 calculates the required power of the load 130, that is, power which needs to be supplied by the fuel cell system 100 to the load 130. The control device 160 determines the output power of the fuel cell 101 and the output power of the secondary battery 120 in the power which needs to be supplied by the fuel cell system 100. The control device 160 controls the FC converter 150 and the battery converter 180 such that each of the fuel cell 101 and the secondary battery 120 is able to supply the determined power. The control device 160 outputs a command value to the inverter 140 and thereby controls the output torque and the number of revolutions of the traction motor 131 so as to obtain a target torque corresponding to the accelerator opening acquired from an accelerator opening sensor included in the sensor group 170.

In FIG. 1, the control device 160 is represented by “CRL 160”. In the control device 160, a function portion which controls the fuel cell system 100 of the fuel cell vehicle 10 is shown as a “controller 162” in FIG. 1.

The controller 162 includes, as the operation modes of the fuel cell system 100, a first operation mode DM1 and a second operation mode DM2. The first operation mode DM1 corresponds to a normal operation. The second operation mode DM2 corresponds to a warm-up operation. The normal operation and the warm-up operation will be described later.

### A2. Configuration and Operation of FC Converter:

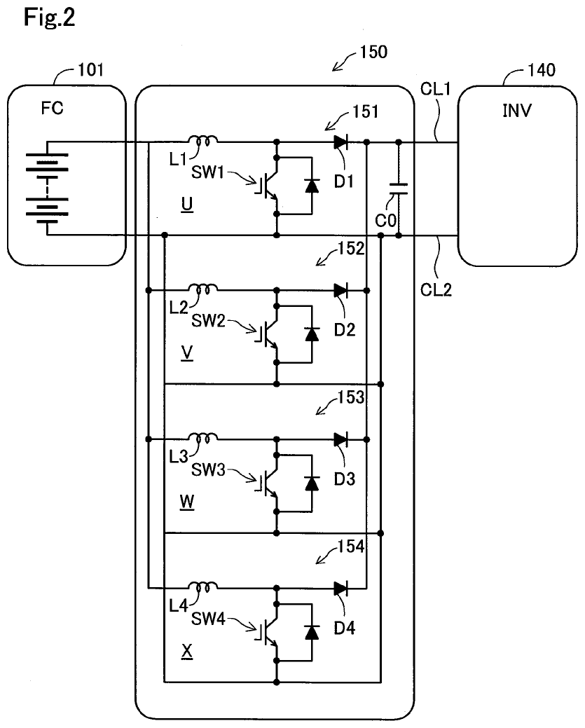

FIG. 2 is a block diagram showing the detailed configuration of the FC converter 150. In the following description, among the circuits of the U phase 151, the V phase 152, the W phase 153 and the X phase 154 included in the FC converter 150, the U phase 151 is used as an example.

The U phase 151 includes a reactor L1, a rectification diode D1 and a switching element SW1.

The reactor L1 is connected to the power supply line CL1 of the fuel cell 101. The rectification diode D1 is connected in series to the reactor L1. The power supply line CL1 of the fuel cell 101 is connected through the reactor L1 and the rectification diode D1 to the inverter 140. On the other hand, the ground line CL2 of the fuel cell 101 is connected to the inverter 140. The power supply line CL1 of the fuel cell 101 and the ground line CL2 of the fuel cell 101 are collectively referred to as the “connection line CL” (see the right portion of the upper row of FIG. 1).

The switching element SW1 is a switching element which includes an IGBT (Insulated Gate Bipolar Transistor). The collector of the switching element SW1 is connected to the power supply line CL1 of the fuel cell 101 between the reactor L1 and the diode D1. The emitter of the switching element SW1 is connected to the ground line CL2 of the fuel cell 101.

The circuits of the V phase 152, the W phase 153 and the X phase 154 included in the FC converter 150 have the same configuration as the U phase 151. In FIG. 2, reactors L2 to L4, diodes D2 to D4 and switching elements SW2 to SW4 included in the circuits of the V phase 152, the W phase 153 and the X phase 154 are shown.

The FC converter 150 further includes a capacitor CO. One end of the capacitor CO is connected to the power supply line CL1 of the fuel cell 101 between the circuits of the U phase 151, the V phase 152, the W phase 153 and the X phase 154 connected in parallel to each other and the inverter 140. The other end of the capacitor CO is connected to the ground line CL2 of the fuel cell 101.

For example, when in the U phase 151, the switching element SW1 is turned on, a current flows from the fuel cell 101 through the reactor L1 to the switching element SW1. Here, the reactor L1 is excited, and thus magnetic energy is accumulated. Thereafter, when the switching element SW1 is turned off, in the power supply line CL1, an induced voltage caused by the magnetic energy accumulated in the reactor L1 is superimposed on the output voltage of the fuel cell 101. Then, since the switching element SW1 is off, the current flows through the diode D1 to the inverter 140.

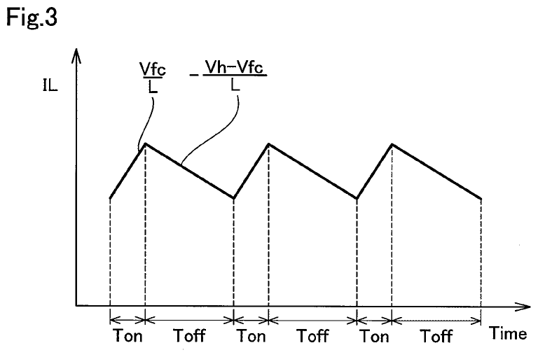

FIG. 3 is a graph showing the current IL of the reactor L1. The controller 162 repeatedly controls the switching element SW1 at regular intervals such that the total value of a time period Ton in which the switching element SW1 is on and a time period Toff in which the switching element SW1 is off is constant (see the lower row of FIG. 3). In the following description, for ease of understanding of the technology, the circuits of the V phase 152, the W phase 153 and the X phase 154 are assumed to be separated from the power supply line CL1.

When the switching element SW1 is on, the current flows from the reactor L1 in the power supply line CL1 through the switching element SW1 toward the ground line CL2 (see the upper row of FIG. 2). The resistance of this route is substantially zero. Here, the current IL flowing through the reactor L1 is linearly increased. When the inductance of the reactor L1 is assumed to be L, the gradient of the current IL flowing through the reactor L1 is Vfc/L.

When the switching element SW1 is off, the current flows from the reactor L1 in the power supply line CL1 through the diode D1 toward the inverter 140 (see the upper row of FIG. 2). Since the switching element SW1 is off, the power supply line CL1 and the ground line CL2 are separated from each other. Here, the current IL flowing through the reactor L1 is linearly decreased. When the voltage of the inverter 140 on an input side, that is, the output voltage of the FC converter 150 is assumed to be Vh, the gradient of the current IL flowing through the reactor L1 is −(Vh−Vfc)/L. The output voltage Vh of the FC converter 150 is the output voltage of the battery converter 180 connected in parallel to the FC converter 150 with respect to the inverter 140 (see the right portion of the upper row of FIG. 1). The output voltage of the FC converter 150, that is, the output voltage of the battery converter 180 is controlled by the battery converter 180.

The controller 162 is able to control the output voltage of the FC converter 150 by operating the duty ratio of the on/off of the switching element SW1 (see the center portion of the lower row of FIG. 1). The “duty ratio” refers to a ratio of the Ton to the total value of the Ton and the Toff, that is, the length of one interval (see the lower row of FIG. 3). As the Ton is longer, that is, as the duty ratio is larger, the output terminal voltage Vfc of the fuel cell 101 is converted into a higher voltage. A step-up capability which is able to be realized by the FC converter 150 is determined by the magnitude of the duty ratio which is able to be realized by the FC converter 150. The step-up capability which is able to be realized by the FC converter 150 is previously determined according to the configuration of the FC converter 150.

Likewise, the controller 162 is able to control the switching elements SW2 to SW4 of the V phase 152, the W phase 153 and the X phase 154. Consequently, the controller 162 is able to control the output voltage Vfc in the FC converter 150 by controlling the FC converter 150 in addition to controlling the output voltage of the battery converter 180, that is, the output voltage of the FC converter 150, using the battery converter 180.

A3. Control of Fuel Cell System with Controller:

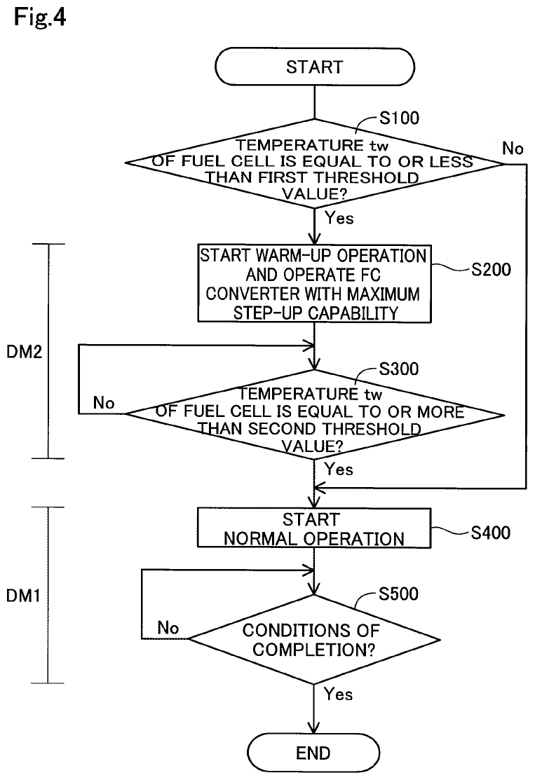

FIG. 4 is a flowchart showing a method of controlling the fuel cell system 100 with the controller. The processing of FIG. 4 is performed with the controller 162 of the control device 160 when the fuel cell system 100 is started up. In a state where the fuel cell vehicle 10 is off a press of the on/off switch of the fuel cell vehicle 10 by a user makes the fuel cell vehicle 10 start up.

In step S100, the controller 162 determines whether or not the temperature tw of the fuel cell 101 is equal to or less than a predetermined first threshold value. The temperature tw of the cooling water for controlling the temperature of the fuel cell is adopted as the temperature tw of the fuel cell 101 (see the left portion of the upper row of FIG. 1). In the present embodiment, the first threshold value is 0° C. When the temperature tw of the fuel cell 101 is equal to or less than the first threshold value, the processing proceeds to step S200. When the temperature tw of the fuel cell 101 is greater than the first threshold value, the processing proceeds to step S400.

In step S200, the controller 162 starts the warm-up operation of the fuel cell 101. Under the situation in which a certain amount of reaction gas is supplied at a certain temperature, the current-voltage characteristics of the fuel cell 101 is as follows: as the current is increased, the voltage is decreased; and as the current is decreased, the voltage is increased. In the warm-up operation, the fuel cell 101 is operated at an operating point at which the current is high and the voltage is low. Then, the fuel cell system 100 is controlled such that the secondary battery 120 is prevented as much as possible from being charged and discharged.

Specifically, in the warm-up operation, the FC converter 150 is operated with the maximum step-up capability which is able to be realized by the FC converter 150 (see a center portion of FIG. 1). Based on the output voltage Vfc of the fuel cell 101 acquired with the voltage sensor VS1, the voltage Vh in the connection line CL is controlled using the battery converter 180 (see the left portion of the upper row of FIG. 1). The warm-up operation of the fuel cell 101 will be described in more detail later.

In step S300, the controller 162 determines whether or not the temperature tw of the fuel cell 101 is equal to or greater than a predetermined second threshold value. The second threshold value is a temperature which is higher than the first threshold value. In the present embodiment, the second threshold value is 50° C. When the temperature tw of the fuel cell 101 is equal to or greater than the second threshold value, the processing proceeds to step S400.

On the other hand, in step S300, when the temperature tw of the fuel cell 101 is less than the second threshold value, the processing is returned to step S300. In step S300, the processing is repeated at regular time intervals. In the meantime, the fuel cell 101 is operated with the controller 162 in the warm-up operation. In FIG. 4, a period in which the warm-up operation as the second operation mode DM2 is performed is shown on a left end.

In step S400, the controller 162 starts the normal operation of the fuel cell 101. Specifically, in the normal operation of the fuel cell 101, the controller 162 calculates power which needs to be supplied by the fuel cell system 100 to the load 130, according to an output requirement indicated by the user through an accelerator pedal and an output which needs to be supplied to the loads other than the traction motor 131. Then, the controller 162 determines the output power of the fuel cell 101 and the output power of the secondary battery 120 in the power which needs to be supplied by the fuel cell system 100. The controller 162 controls the FC converter 150 and the battery converter 180 such that each of the fuel cell 101 and the secondary battery 120 is able to supply the determined power.

In the normal operation, the FC converter 150 is operated with various step-up capabilities which are able to be realized by the FC converter 150 (see the center portion of FIG. 1 and FIG. 3). More specifically, the FC converter 150 is operated with various step-up capabilities which include step-up capabilities lower than the step-up capability of the FC converter 150 in the warm-up operation (see the center portion of FIG. 1 and FIG. 3). Consequently, the output voltage Vfc of the fuel cell 101 is able to take various values which include values larger than in the case of the warm-up operation.

In step S500, the controller 162 determines whether or not the conditions of completion of the operation of the fuel cell 101 are satisfied. The conditions of completion of the operation of the fuel cell 101 include a condition that the on/off switch of the fuel cell vehicle 10 is pressed, when the fuel cell vehicle 10 is on. In step S500, when the conditions of completion of the operation of the fuel cell 101 are satisfied, the processing is completed.

On the other hand, in step S500, when the conditions of completion of the operation of the fuel cell 101 are not satisfied, the processing is returned to step S500. In step S500, the processing is repeated at regular time intervals. In the meantime, the fuel cell 101 is operated with the controller 162 in the normal operation. In FIG. 4, a period in which the normal operation as the first operation mode DM1 is performed is shown on the left end.

### A4. Control of Fuel Cell System in Warm-Up Operation:

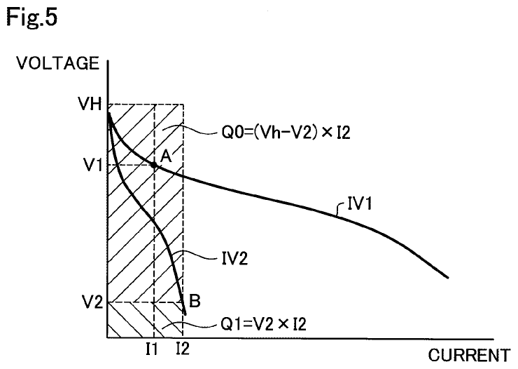

FIG. 5 is an illustrative diagram showing the current-voltage characteristics of fuel cell 101. A curve IV1 indicates current-voltage characteristics in the normal operation. A curve IV2 indicates current-voltage characteristics in the warm-up operation.

In the normal operation, the controller 162 operates the fuel cell 101 at an operating point on the curve IV1. An example of the operating point on the curve IV1 is assumed to be an operating point A. A current at the operating point A is assumed to be I1. A voltage at the operating point A is assumed to be V1. At the operating point A, energy obtained from hydrogen is [VH×I1]. VH represents a theoretical electromotive force in a state where no load is connected to the fuel cell, and is calculated from the enthalpy of combustion of hydrogen, that is, [ΔH=−286 kj/mol]. Specifically, VH is calculated by dividing the enthalpy of combustion by Faraday constant and the number of reaction electrons (in this reaction, “2”). VH is normally a value higher than an OCV which is an open circuit voltage.

At the operating point A, [VI×I1], which corresponds to a portion lower than the operating point A in FIG. 5, in the energy [VH×IV] obtained from hydrogen is electrical energy. [(VH−V1)−I1] corresponding to a portion higher than the operating point A is thermal energy.

In the warm-up operation, the controller 162 operates the fuel cell 101 at an operating point on the curve IV2. In the present embodiment, the operating point on the curve IV2 at which the warm-up operation is performed is assumed to be an operating point B. A current at the operating point B is assumed to be I2. A voltage at the operating point B is assumed to be V2. At the operating point B, energy obtained from hydrogen is [VH×I2].

At the operating point B, [Q1=V2×I2], which corresponds to a portion lower than the operating point B in FIG. 5, in the energy [VI1×I2] obtained from hydrogen is electrical energy. [Q0=(VI1−V2)×I2] corresponding to a portion higher than the operating point B is thermal energy.

In the normal operation, the controller 162 operates the fuel cell 101 at various operating points on the curve IV1 (see the DM1 in FIG. 4). Hence, in the normal operation, the FC converter 150 is operated with various step-up capabilities which are able to be realized by the FC converter 150. In the present embodiment, the step-up capabilities which are able to be realized by the FC converter 150 are step-up capabilities at duty ratios of 5 to 95% (see the lower row of FIG. 3).

In the warm-up operation, the controller 162 is operated at an operating point at which the ratio of output thermal energy is the highest in a range that is able to be realized. That is, the controller 162 is operated at an operating point which has a high current and a low voltage (see the DM2 in FIG. 4). Hence, in the warm-up operation, the FC converter 150 is operated with the maximum step-up capability which is able to be realized by the FC converter 150. The maximum step-up capability which is able to be realized by the FC converter 150 is the maximum step-up capability in which the manufacturer of the FC converter 150 insures its operation. In the present embodiment, the maximum step-up capability which is able to be realized by the FC converter 150 is a step-up capability at a duty ratio of 95% (see the lower row of FIG. 3). The operation of the FC converter 150 with the maximum step-up capability which is able to be realized by the FC converter 150 is realized as follows.

The controller 162 (see the center portion of the lower row of FIG. 1) uses the battery converter 180 so as to control the voltage Vh in the connection line CL (see the right portion of the upper row of FIG. 1). The output voltage of the battery converter 180 is controlled by the controller 162 to be a voltage suitable for the load 130.

In the warm-up operation, the controller 162 controls the fuel gas supplier 105 so as to supply a sufficient amount of hydrogen gas to the fuel cell 101 (see the left portion of the upper row of FIG. 1). On the other hand, the controller 162 controls the oxidizing gas supplier 103 so as to supply air including the amount of oxygen which is insufficient for a reaction with the amount of hydrogen. Hence, by the amount of oxygen included in the air supplied to the fuel cell 101 with the oxidizing gas supplier 103 per unit time, the amount of electrons which flow out from the fuel cell 101 per unit time is determined. Consequently, the controller 162 controls the output current of the fuel cell 101 by controlling the oxidizing gas supplier 103. In other words, in the warm-up operation, the controller 162 controls the output current of the fuel cell 101 using the oxidizing gas supplier 103 (see the left portion of the upper row of FIG. 1).

The controller 162 instructs the FC converter 150 to output, from the fuel cell 101, a large current value which is not able to be realized by the temperature and the amount of oxidizing gas supplied at that time.

Under the situation in which a certain amount of reaction gas is supplied at a certain temperature, the current-voltage characteristics of the fuel cell 101 is as follows: as the current is increased, the voltage is decreased; and as the current is decreased, the voltage is increased (see the IV2 of FIG. 5). Hence, the FC converter 150 receiving the instruction for the large current value which is not able to be realized operates with the maximum step-up capability which is able to be realized by the FC converter 150. Accordingly, the fuel cell 101 is operated at the lowest voltage Vfc which is able to be realized for the voltage Vh in the connection line CL, and thus the output current of the fuel cell is increased. Consequently, the FC converter 150 is operated with the maximum step-up capability which is able to be realized by the FC converter 150. That is, the FC converter 150 is operated at a duty ratio of 95% in the present embodiment. The lowest voltage Vfc which is able to be realized for the voltage Vh is represented by V2 in FIG. 5.

Depending on the state of the fuel cell 101, the voltage may be displaced downward with respect to the operating point B which is the target (see the IV2 of FIG. 5). However, in such a case, due to the characteristics of the fuel cell, the output current is reduced, and the output voltage is increased. Hence, the fuel cell 101 is stably operated at the operating point B.

In a conventional technology, as in the normal operation, even in the warm-up operation, the fuel cell system 100 is controlled by operating the duty ratio in the FC converter 150. Hence, when the output voltage of the FC converter 150 is lower than a scheduled value, an upper limit is provided for the target value of the duty ratio in the FC converter 150 such that the output voltage is further increased. The upper limit for the target value of the duty ratio is a value which is lower than the maximum value of the duty ratio which is able to be realized by the FC converter 150. Likewise, when the output voltage of the FC converter 150 is higher than the scheduled value, a lower limit is provided for the target value of the duty ratio in the FC converter 150 such that the output voltage is further decreased. The lower limit for the target value of the duty ratio is a value which is higher than the minimum value of the duty ratio which is able to be realized by the FC converter 150. Then, within a range between the upper limit and the lower limit, the control of the fuel cell system 100 in the warm-up operation is performed. For example, the target value of the duty ratio in the FC converter 150 is set to 8 to 92%. Hence, it is impossible to perform an efficient warm-up operation in which the FC converter 150 is operated with the maximum step-up capability (i.e. the maximum duty ratio) that is able to be realized by the FC converter 150 to operate the fuel cell 101 at the lowest voltage Vfc that is able to be realized.

On the other hand, in the present embodiment, in the warm-up operation serving as the second operation mode DM2, the output voltage Vfc of the fuel cell 101 is stepped up with the maximum step-up capability which is able to be realized by the FC converter 150. Hence, the fuel cell 101 is operated such that the output voltage Vfc of the fuel cell 101 is the lowest voltage which is able to be realized for the voltage Vh in the connection line CL. Consequently, the fuel cell 101 is operated with the substantially fixed state of the operation such that the fuel cell 101 generates the maximum amount of heat which is able to be realized in the state of the fuel cell system 100 at that time (see the IV2 and the Q0 of FIG. 5). On the other hand, the output of the fuel cell 101 is controlled through the control of the amount of current using the oxidizing gas supplier 103. Hence, while the warm-up operation is being effectively performed in the second operation mode DM2, it is possible to prevent a problem where the operating point which is a combination of the output voltage Vfc and the output current of the fuel cell 101 is significantly displaced from the scheduled operating point B.

Consequently, it is unnecessary to store large power in the secondary battery 120 or to make the secondary battery 120 supply large power under an environment of a low temperature at which the warm-up operation is performed (see the right portion of the middle row of FIG. 1). Hence, it is possible to prevent a problem in which the performance of the secondary battery 120 is lowered. It is also unnecessary to wastefully consume power generated with the fuel cell 101 in the warm-up operation in the load 130 other than the traction motor 131, in order to prevent the secondary battery 120 from being charged or discharged. Then, it is substantially unnecessary to perform control using the control device 160 so as to consume, in the load 130 other than the traction motor 131, the power generated with the fuel cell 101 in the warm-up operation in order to prevent the secondary battery 120 from being charged or discharged.

In the present embodiment, in the warm-up operation, the controller 162 controls the voltage Vh in the connection line CL with the battery converter 180 in a state where the duty ratio in the FC converter 150 is substantially fixed to the maximum duty ratio which is able to be realized (see the right portion of the upper row of FIG. 1). The duty ratio here is 95% in the present embodiment. In other words, the FC converter 150 steps up the output terminal voltage Vfc of the fuel cell 101 to 20 times the output terminal voltage Vfc. The controller 162 controls the output terminal voltage Vfc of the fuel cell 101, by controlling the output voltage Vh of the FC converter, twenty times as accurately as the configuration in which the input voltage of the output voltage Vh of the FC converter 150 (i.e. the output terminal voltage Vfc of the fuel cell 101) is controlled.

In the present embodiment, in the warm-up operation, based on the output voltage Vfc of the fuel cell 101 acquired with the voltage sensor VS1, the controller 162 controls the voltage Vh in the connection line CL using the battery converter 180 (see the right portion of the upper row of FIG. 1). In the warm-up operation, the FC converter 150 is operated so as to achieve the maximum step-up capability. Accordingly, the output voltage Vfc of the fuel cell 101 is feedback controlled to a desired value by controlling the voltage Vh in the connection line CL based on the output voltage Vfc of the fuel cell 101.

The oxidizing gas supplier 103 and the fuel gas supplier 105 in the present embodiment are also collectively referred to as a “reaction gas supplier”. The FC converter 150 is also referred to as a “first converter”. The controller 162 serving as the function portion of the control device 160 and the fuel cell system 100 are also collectively referred to as a “fuel cell system”. The battery converter 180 is also referred to as a “second converter”. The normal operation is also referred to as a “first operation mode”. The warm-up operation is also referred to as a “second operation mode”. The voltage sensor VS1 is also referred to as a “voltage acquirer”.

Steps S200 and S300 of FIG. 4 in the present embodiment are also referred to as a “step of controlling the fuel cell system in the first operation mode”. Steps S400 and S500 of FIG. 4 are also referred to as a “step of controlling the fuel cell system in the second operation mode”.

### B. Other Embodiments

### B1. Other Embodiment 1

(1) In the embodiment described above, the FC converter 150 is a four-phase parallel converter which is configured with the U phase 151, the V phase 152, the W phase 153 and the X phase 154 that are connected in parallel to each other. However, as the converter which converts the output voltage of the fuel cell, a converter which has another number of phases such as one phase, two phases, three phases or five or more phases may be used.

The converter which converts the output voltage of the fuel cell may use, in the conversion of the voltage, one or more phases of N phases included in the converter. For example, the converter may use, according to power required from the load, the number of phases in which efficiency is achieved.

(2) In the embodiment described above, as the temperature of the fuel cell 101, the temperature tw of the cooling water in the fuel cell 101 is used (see the left portion of the upper row of FIG. 1 and S100 in FIG. 4). However, as the temperature of the fuel cell, for example, another temperature, such as the temperature of the fuel cell itself or the temperature of a structure connected to the fuel cell, which has a correlation with the temperature of the fuel cell may be used.

(3) In the embodiment described above, in the warm-up operation, the control device 160 uses the oxidizing gas supplier 103 so as to control the output current of the fuel cell 101 (see the left portion of the upper row of FIG. 1). However, in the warm-up operation, the control device 160 may use the fuel gas supplier 105 singly or together with the oxidizing gas supplier 103 so as to control the output current of the fuel cell 101. In other words, the output current of the fuel cell 101 is preferably controlled by adjusting at least one of the amount of fuel gas and the amount of oxidizing gas supplied to the fuel cell 101.

(4) In the embodiment described above, in the warm-up operation, the control device 160 instructs the FC converter 150 to output, from the fuel cell 101, a large current value which is not able to be realized by the temperature and the amount of oxidizing gas supplied at that time. Consequently, the FC converter 150 is operated with the maximum step-up capability which is able to be realized by the FC converter 150, and thus the fuel cell 101 is operated at the lowest voltage Vfc which is able to be realized for the voltage Vh in the connection line CL (see FIGS. 1 and 5). However, in the warm-up operation, the control device 160 may instruct the FC converter 150 to be operated with the maximum step-up capability which is able to be realized by the FC converter 150.

(5) In the embodiment described above, the secondary battery 120 is a lithium-ion cell. However, as the secondary battery which is able to store power generated with the fuel cell and power generated with the motor serving as a power generator, instead of the lithium-ion cell, another secondary battery, such as a nickel metal hydride cell or a lead acid cell, may be used. However, under an environment of a low temperature, the charging capability and the discharging capability of the lithium-ion cell is significantly lowered. Hence, the method of controlling the fuel cell in the present disclosure is suitable for the configuration in which the lithium-ion cell is adopted as the secondary battery.

### B2. Oher Embodiment 2

In the embodiment described above, the fuel cell system 100 includes the FC converter 150 and the battery converter 180 (see the center portion of the upper row of FIG. 1). However, a configuration may be adopted in which the fuel cell system 100 includes the FC converter 150 and does not include the battery converter 180. In the configuration described above, the warm-up operation is performed as follows. In a case where the output voltage Vfc of the fuel cell 101 when the FC converter 150 is operated with the maximum step-up capability which is able to be realized by the FC converter 150 is a voltage within a predetermined allowable range, the FC converter 150 is operated with the maximum step-up capability which is able to be realized by the FC converter 150. In a case where the output voltage Vfc of the fuel cell 101 when the FC converter 150 is operated with the maximum step-up capability which is able to be realized by the FC converter 150 falls outside the allowable range described above, a step-up ratio in the FC converter 150 is determined such that the output voltage Vfc falls within the allowable range, and thus the FC converter 150 is operated at the step-up ratio.

### B3. Other Embodiment 3

In the embodiment described above, based on the output voltage Vfc of the fuel cell 101 acquired with the voltage sensor VS1, the control device 160 uses the battery converter 180 so as to control the voltage Vh in the connection line CL. However, the control device 160 may control the voltage Vh in the connection line CL without being based on the output voltage Vfc of the fuel cell 101.

### B4. Other Embodiment 4

In the embodiment described above, when the temperature tw of the fuel cell 101 is a temperature which serves as the first threshold value and which is equal to or less than 0° C., the warm-up operation is performed (see S100 and S200 of FIG. 4). However, as the first threshold value, another value such as 1° C. or 3° C. may be adopted. As the condition in which the warm-up operation is started, in addition to the temperature of the fuel cell at that time, for example, another condition may be included in which the temperature of the fuel cell in a past predetermined time period is equal to or less than a threshold value. A plurality of conditions described above may be parallel conditions or loading conditions. In other words, the warm-up operation serving as the second operation mode is preferably performed under predetermined conditions.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the present disclosure, a fuel cell system is provided. The fuel cell system includes: a fuel cell; a reaction gas supplier which supplies a fuel gas and an oxidizing gas to the fuel cell; a first converter which converts the output voltage of the fuel cell; a secondary battery; a connection line for connecting the output end of the first converter and the output end of the secondary battery in parallel to a load; and a controller which controls the fuel cell system. The controller includes, as operation modes of the fuel cell system, a first operation mode and a second operation mode. The first operation mode is an operation mode in which the first converter is operated with a step-up capability that is able to be realized by the first converter, and the second operation mode is an operation mode in which the first converter is operated with the maximum step-up capability that is able to be realized by the first converter and in which the reaction gas supplier is used to control the output current of the fuel cell.

In the aspect as described above, in the second operation mode, the output voltage of the fuel cell is stepped up with the maximum step-up capability which is able to be realized by the first converter. Hence, the fuel cell is operated such that the output voltage of the fuel cell is the lowest voltage which is able to be realized for the voltage in the connection line. Consequently, the fuel cell is operated with the state of the operation substantially fixed such that the fuel cell enters the state of the operation capable of generating the maximum amount of heat which is able to be realized in the fuel cell system at that time. On the other hand, the output of the fuel cell is controlled through the control of the amount of current using the oxidizing gas supplier. Hence, while the warm-up operation is being effectively performed in the second operation mode, it is possible to prevent a problem where the operating point which is a combination of the output voltage and the output current of the fuel cell is significantly displaced from the scheduled operating point.

(2) The fuel cell system of the aspect described above may further include: a second converter which converts the output voltage of the secondary battery, the connection line may be connected through the second converter to the output end of the secondary battery and in the first operation mode and the second operation mode, a voltage in the connection line may be controlled with the second converter.

In the aspect as described above, it is possible to supply the power at the voltage suitable for the load.

(3) The fuel cell system of the aspect described above may further include: a voltage acquirer which acquires the output voltage of the fuel cell, and in the second operation mode, based on the output voltage of the fuel cell acquired with the voltage acquirer, the controller may use the second converter so as to control the voltage in the connection line.

In the aspect as described above, the voltage in the connection line is controlled based on the output voltage of the fuel cell, and thus it is possible to perform feedback control such that the output voltage of the fuel cell is a desired value.

(4) According to another aspect of the present disclosure, there is provided a method of controlling a fuel cell system which includes a fuel cell, a first converter which converts the output voltage of the fuel cell, a secondary battery and a connection line for connecting the output end of the first converter and the output end of the secondary battery in parallel to a load. The method of controlling a fuel cell system includes: (a) a step of controlling the fuel cell system in a first operation mode; and (b) a step of controlling the fuel cell system in a second operation mode when a predetermined condition is satisfied. The first operation mode is an operation mode in which the first converter is operated with a step-up capability that is able to be realized by the first converter. The second operation mode is an operation mode in which the first converter is operated with the maximum step-up capability that is able to be realized by the first converter and in which at least one of the amount of fuel gas and the amount of oxidizing gas supplied to the fuel cell is adjusted such that the output current of the fuel cell is controlled.

In the aspect as described above, in the second operation mode, the output voltage of the fuel cell is stepped up with the maximum step-up capability which is able to be realized by the first converter. Hence, the fuel cell can be operated such that the output voltage of the fuel cell is the lowest voltage which is able to be realized for the voltage in the connection line. Consequently, while the output of the fuel cell is being controlled through the control of the amount of current by the adjustment of at least one of the amount of fuel gas and the amount of oxidizing gas, the fuel cell can be operated at the lowest voltage which is able to be realized. Hence, while the warm-up operation is being effectively performed in the second operation mode, it is possible to prevent a problem where the operating point which is a combination of the output voltage and the output current of the fuel cell is significantly displaced from the scheduled operating point.

(5) In the method of controlling a fuel cell system according to the aspect described above, the fuel cell system may further include a second converter which converts the output voltage of the secondary battery, the connection line may be connected through the second converter to the output end of the secondary battery and in the first operation mode and the second operation mode, a voltage in the connection line may be controlled with the second converter. In the aspect as described above, it is possible to supply the power at the voltage suitable for the load.

(6) In the method of controlling a fuel cell system according to the aspect described above, in the second operation mode, based on the output voltage of the fuel cell, the second converter may be used so as to control the voltage in the connection line.

In the aspect as described above, the voltage in the connection line is controlled based on the output voltage of the fuel cell, and thus it is possible to perform feedback control such that the output voltage of the fuel cell is a desired value.

The present disclosure is able to be realized in various aspects other than the fuel cell system and the method of controlling a fuel cell system. For example, it is possible to realize aspects such as a fuel cell vehicle and a method of controlling a fuel cell vehicle, computer programs which realize the control methods described above and a non-transitory recording medium which records the computer programs.

What is claimed is:

1. A fuel cell system comprising:
a fuel cell;
a reaction gas supplier which supplies a fuel gas and an oxidizing gas to the fuel cell;
a first converter which converts an output voltage of the fuel cell;
a secondary battery;
a connection line connecting an output end of the first converter and an output end of the secondary battery in parallel to a load; and
a controller which controls the fuel cell system,
wherein the controller includes, as operation modes of the fuel cell system, a first operation mode and a second operation mode,
the first operation mode is an operation mode in which the first converter is operated with a step-up capability that is able to be realized by the first converter and
the second operation mode is an operation mode
in which the first converter is operated with a maximum step-up capability that is able to be realized by the first converter and
in which the reaction gas supplier is used to control an output current of the fuel cell.

2. The fuel cell system according to claim 1, further comprising:
a second converter which converts an output voltage of the secondary battery,
wherein the connection line is connected through the second converter to the output end of the secondary battery, and
in the first operation mode and the second operation mode, a voltage in the connection line is controlled with the second converter.

3. The fuel cell system according to claim 2, further comprising:
a voltage acquirer which acquires the output voltage of the fuel cell,
wherein in the second operation mode, based on the output voltage of the fuel cell acquired with the voltage acquirer, the controller controls the voltage in the connection line using the second converter.

4. A method of controlling a fuel cell system, the fuel cell system including: a fuel cell; a first converter which converts an output voltage of the fuel cell; a secondary battery; and a connection line connecting an output end of the first converter and an output end of the secondary battery in parallel to a load,
the method comprising:
(a) controlling the fuel cell system in a first operation mode; and
(b) controlling the fuel cell system in a second operation mode when a predetermined condition is satisfied,
wherein the first operation mode is an operation mode in which the first converter is operated with a step-up capability that is able to be realized by the first converter, and
the second operation mode is an operation mode
in which the first converter is operated with a maximum step-up capability that is able to be realized by the first converter and
in which an output current of the fuel cell is controlled by adjusting at least one of an amount of fuel gas and an amount of oxidizing gas supplied to the fuel cell.

5. The method of controlling a fuel cell system according to claim 4,
wherein the fuel cell system further includes a second converter which converts an output voltage of the secondary battery,
the connection line is connected through the second converter to the output end of the secondary battery and
in the first operation mode and the second operation mode, a voltage in the connection line is controlled with the second converter.

6. The method of controlling a fuel cell system according to claim 5,
wherein in the second operation mode, based on the output voltage of the fuel cell, the voltage in the connection line is controlled using the second converter.
